(19) United States
(12) Patent Application Publication
(10) Pub. No.: US 2006/0150152 A1
(43) Pub. Date: Jul. 6, 2006

(54) System and method for providing mobile publishing and searching directly from terminals

(75) Inventors: Veli-Matti Soini, Toijala (FI); Kimmo Hamynen, Espoo (FI)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/028,899

(22) Filed: Jan. 3, 2005

(51) Int. Cl. G06F 9/44

(52) U.S. Cl. 717/116; 717/108

(57) ABSTRACT

A system and method for quickly and easily making selective mobile device content available to other devices on a network. The mobile device includes a web server/http server. The user is provided with the ability to designate text, messages, audio files, images, video files, and other information for publication, upon which the respective files are copied or transferred to the web server/http server and therefore made available to other devices within a network.

### FIELD OF THE INVENTION

The present invention relates generally to mobile terminals. More particularly, the present invention relates to mobile terminals where content is made available for public access.

### BACKGROUND OF THE INVENTION

A wide variety of portable electronic devices are widely available for both personal and business use. For example, there are a wide variety of types of cellular telephones, portable radio communications devices, personal digital assistants (PDA), and combinations thereof currently on the market. These devices provide a wide range of services, ranging from Internet access to electronic mail to personal organization systems, to even various electronic games.

As these types of devices have advanced in their capabilities in recent years, users have been able to store a constantly increasing range and number of files on their respective devices. For example, users can now create and store an enormous amount of text files, graphics, audio clips, video clips, and other types of information on their devices for their own personal use and/or for making information available to others.

When it comes to making such content available to others, however, there are currently a number of drawbacks to present mobile devices. For example, it currently is very tedious for a user to publish personal content in the mobile internet and, as a result, very little content is being currently provided by mobile subscribers today. In many cases, this is due to the fact that, even though people are creating a lot of short messaging service (SMS) or multimedia messaging service (MMS) messages on their terminals, they do not have the ability to publish information to other people without sending the message or transferring the content to another media format. The small amount of content that is made available is often difficult to find through internet search engines among the vast amount of fixed internet content.

One prior solution to the difficulty in making content available from a mobile device has been for the user to create a web page on a personal computer for publishing noteworthy messages or content through a multimedia messaging service. Unfortunately, however, this process can be just as time consuming as directly converting the content to make it available directly from the mobile device.

Some mobile community services and mobile-enabled internet community services permit mobile subscribers to share content with other users by uploading content from their own devices to community servers. The uploaded content can then be accessed by other members of the same community. In some instances, the content can also be found through standard internet search engines. However, this process also requires additional infrastructure, requires activity among multiple devices, and still may not make desired content widely accessible to others.

It would therefore be desirable to have an improved system for a mobile electronic device that overcomes the above-identified shortcomings.

### SUMMARY OF THE INVENTION

The present invention provides a system and method for a user to quickly and easily identify content on his or her own mobile electronic device to be made available on a local or wide area network. When a user desires for a certain content to be widely available, he or she simply designates that particular material as public for availability. When so marked, the material or content can be accessed and found by others on a network and/or through mobile search engines.

The present invention provides for a method of selectively making material on an electronic device available on a network, comprising the steps of selecting an object on the electronic device; placing the object on a web page located on the electronic device; placing the object on a server located on the electronic device; and making the object on the server available outside of the electronic device.

The present invention also provides for a computer program product for selectively making material on an electronic device available on a network, comprising computer code for selecting an object on the electronic device; computer code for placing the object on a web page located on the electronic device; computer code for placing the object on a server located on the electronic device; and computer code for making the object on the server available outside of the electronic device.

In addition, the present invention provides for an electronic device, comprising: a controller; a server operatively connected to the controller, and a memory unit operatively connected to the controller and the server. The memory unit includes computer code for selecting an object on the module; computer code for placing the object on a web page located on the electronic device; computer code for placing the object on the server; and computer code for making the object on the server available outside of the electronic device.

The present invention also provides for a module, comprising a controller; a server operatively connected to the controller, and a memory unit operatively connected to the controller and the server. The memory unit includes computer code for selecting an object on the module; computer code for placing the object on a web page located on the electronic device; computer code for placing the object on the server; and computer code for making the object on the server available outside of the module

The present invention provides the user with a number of distinct advantages over conventional systems. The present invention enables the easy publishing of personal content in a mobile internet. The present invention also enables easy and effective search for content published by other mobile subscribers. Using the present invention, a user can search for content with a minimal amount of risk for the device to be infected by viruses or other malicious files. The present invention can provide for content to be available on either broad-based or limited networks such as community groups. Furthermore, the present invention can be implemented with a simple user interface, permitting fast navigation and without any need to use menu keys. All navigation and browsing could be accomplished with the use of a joystick or similar input device.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system according to the present invention;

FIG. 2 is a perspective view of a mobile telephone that can be used in the implementation of the present invention; and

FIG. 3 is a schematic representation of the telephone circuitry of the mobile telephone of FIG. 2;

FIG. 4 is a representation of a generic display showing the implementation of one embodiment of the present invention; and

FIG. 5 is a flow chart showing the steps involved in implementing the present invention according to one embodiment thereof.

### DETAILED DESCRIPTION OF THE PREFERRED EMBODIMENTS

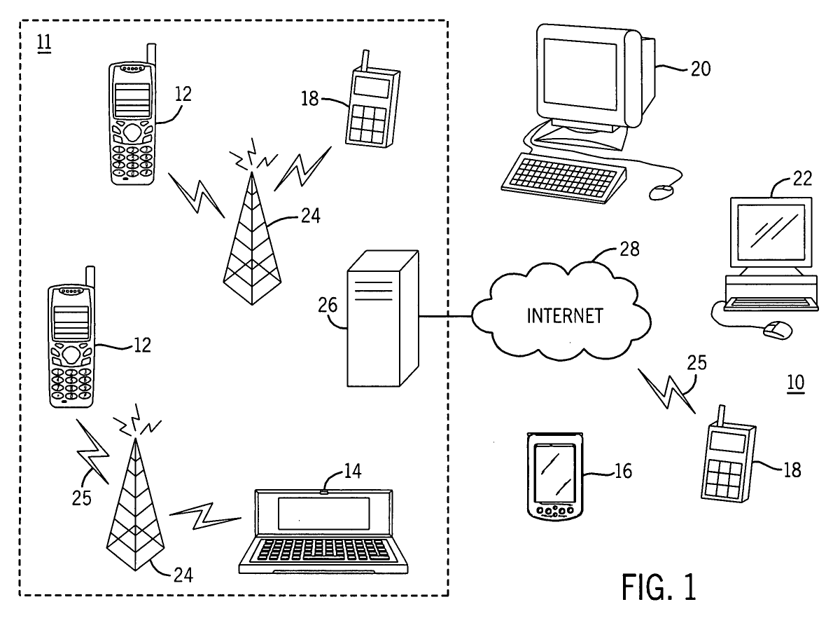

FIG. 1 shows a generic system 10 within which the present invention may be implemented. For exemplification, the generic system 10 shown in FIG. 1 includes a mobile network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the generic system 10 may include, but are not limited to, a mobile telephone 12, a combination PDA and mobile telephone 14, a PDA 16, an IMD 18, a desktop computer 20, a notebook computer 22, etc. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

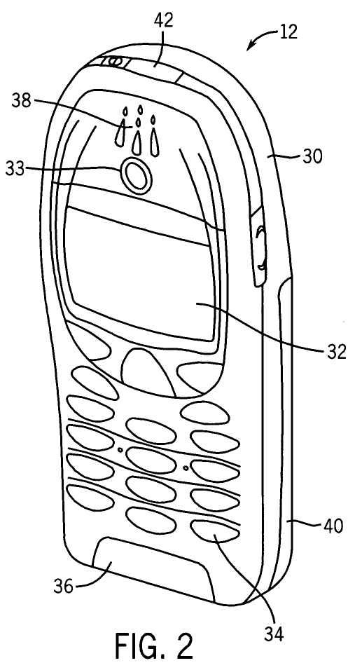

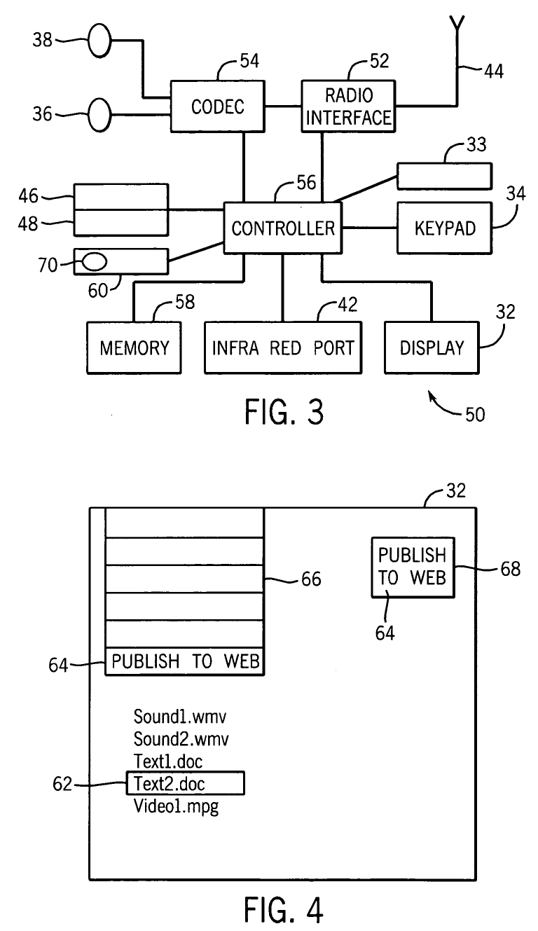

FIGS. 2 and 3 show one representative mobile telephone 12 according to one embodiment of the invention. However, it should be understood that the present invention is not limited to one particular type of mobile telephone 12 or other electronic device, instead being applicable to virtually any mobile electronic device. The mobile telephone 12 of FIGS. 2 and 3 includes a housing 30, a display 32 in the form of a liquid crystal display, a keypad 34, an input device 33, a microphone 36, an ear-piece 38, a battery 40, an infrared port 42, an antenna 44, a smart card 46 in the form of a universal integrated circuit card (UICC) according to one embodiment of the invention, a card reader 48, and mobile telephone circuitry 50. The mobile telephone circuitry 50 includes radio interface circuitry 52, coded circuitry 54, a controller 56 and a memory 58. Individual circuits and elements are all of a type well known in the art, for example in the Nokia range of mobile telephones.

The present invention permits users of electronic devices such as mobile telephones 12 to publish on a local or wide area network any SMS, MMS or other content created, stored or manipulated on the electronic device. In the mobile telephone 12 of FIGS. 2 and 3, there is included a built-in web server/http server 60. It should be noted that the web server/http server 60 can formed either completely separate from or as part of the memory 58 and/or the controller 56.

The present invention allows for a user to quickly and easily select content on the mobile telephone 12 or other mobile device to be placed on the web server/http server. FIG. 4 shows a generic display 32 through which the present invention may be implemented. The display includes a number of different files 62. These files 62 can include, but are not limited to, SMS messages, MMS messages, office documents, text, recorded voice, music or other audio, pictures, videos, animations and other content. Preferably, the content is named using descriptive names or attached with descriptive text that can be used for search purposes.

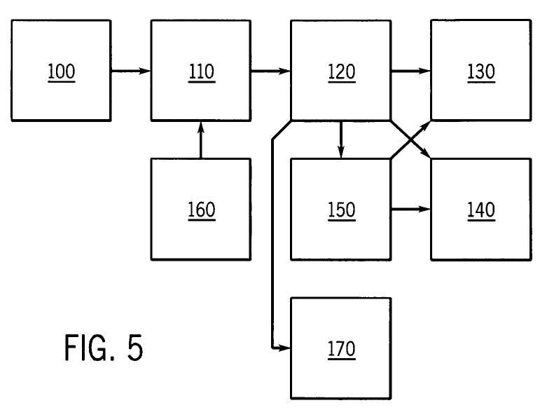

In the embodiment shown in FIG. 4, the user can “publish” a particular file 62 by highlighting the desired file 62 and selecting a “publish to web” option 64 using the input device 33. The input device 33 can take a wide variety of forms, including a conventional mouse, a touch pad, a joystick, or other devices. It is also possible for the display 32 to be touch-sensitive so as to also serve as the input device 33. FIG. 5 is a flow chart showing this process according to one embodiment of the invention, where the desired file 62 is selected at step 100 for publication. The “publish to web” option 64 can be placed in virtually any location on the display 32, For example, the “publish to web” option 64 can be placed in a drop down menu 66, as a separate icon 68, as a box to be checked next to the desired file 62, or in another location. If the input device 33 has the form of a conventional computer mouse, for example, the “publish to web” option 64 can be a “left click” or “right click” option as well. The “publish to web” option 64 can be tied into any particular program, such as SMS and/or MMS applications, or it could be standard across multiple applications.

When the “publish to web” option 64 is selected for a particular file 62, the controller 56 copies and/or transfers the file 62 to a web page (for example, using xHTML, WML or HTML formats) at step 110. The file 62 is then copied to a folder 70 within the web server/http server 60 at step 120. The folder 70 can then be fetched from outside the mobile telephone 12 or other electronic device like a conventional web page by another individual at step 130. The file 62 can also be accessed by and found through mobile and/or Internet-based search engines at step 140. In one embodiment of the invention, software stored in the memory 58 automatically registers the new content to a preferred mobile search engine at step 150, making the content searchable for all mobile subscribers.

In addition to the above, a user can also use various other options regarding the content that is published. For example, a user can define user rights to individual web content as necessary at step 160. For example, a user could use a personal phonebook to select individuals who may be given access to select files. In another embodiment of the invention, the marking of a piece of content as public also generates a notification for the user at step 170 that this piece of content will subsequently be openly published. In yet another embodiment of the invention, the user can select one of a plurality of templates for exhibiting the selected content. The user can also use of a plurality of different parameters for selecting the content to be published. For example, the user can direct that all image files created after a certain date should or should not be published, or that all files in a certain location should or should not be published. Additionally, the present invention can also be implemented through the use of web services in a manner otherwise substantially identical to the methods describe above.

In one embodiment of the invention, the user is also provided with the ability to limit or restrict the individuals who would be able to access and/or view the published content. For example, a user could decide that any person could access the information (an “open” system), or that only a selected group of individuals (such as those in the user's address book) can access the content. For those individuals who will be given access, the user's terminal can send a content key via SMS to those individuals for accessing the content, which can be DRM-encrypted so that others cannot access it. Other similar systems can also be used.

The present invention is described in the general context of method steps, which may be implemented in one embodiment by a program product including computer-executable instructions, such as program code, executed by computers in networked environments.

Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represent examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module” as used herein, and in the claims, is intended to encompass implementations using one or more lines of software code, and/or hardware implementations, and/or equipment for receiving manual inputs.

While several embodiments have been shown and described herein, it should be understood that changes and modifications can be made to the invention without departing from the invention in its broader aspects. For example, but without limitation, the present invention could be incorporated into a wide variety of electronic devices, such as cellular telephones, personal digital assistants, and other devices. Additionally, the various steps depicted in FIG. 5 can be combined as necessary, and the order of the steps can also be altered as necessary or desired. Various features of the invention are defined in the following Claims:

What is claimed is:

1. A method for selectively making material on an electronic device available on a network, comprising the steps of:
selecting an object on the electronic device;
placing the object on a web page located on the electronic device;
placing the object on a server located on the electronic device; and
making the object on the server available outside of the electronic device.

2. The method of claim 1, wherein the selection of the object includes actuating an icon on a display.

3. The method of claim 1, wherein the selection of the object includes selecting an option from a drop-down menu on a display.

4. The method of claim 1, further comprising the step of, after selecting the object, having the electronic device inform a user that the selected object will become available outside of the electronic device.

5. The method of claim 1, further comprising the step of automatically registering the object with a search engine.

6. The method of claim 1, wherein the object is selected from a group consisting of a MMS message, a SMS message, an audio file, a video file, a text file, and an image file.

7. The method of claim 1, further comprising the step of enabling a user to define rights to the object for those outside of the electronic device.

8. The method of claim 1, further comprising the step of selecting one of a plurality of templates for displaying the object on the web page.

9. A computer program product for selectively making material on an electronic device available on a network, comprising:
computer code for selecting an object on the electronic device;
computer code for placing the object on a web page located on the electronic device;
computer code for placing the object on a server located on the electronic device; and
computer code for making the object on the server available outside of the electronic device.

10. The computer program product of claim 9, wherein the selection of the object includes actuating an icon on a display.

11. The computer program product of claim 9, wherein the selection of the object includes selecting an option from a drop-down menu on a display.

12. The computer program product of claim 9, further comprising computer code for, after selecting the object, having the electronic device inform a user that the selected object will become available outside of the electronic device.

13. The computer program product of claim 9, further comprising computer code for automatically registering the object with a search engine.

14. The computer program product of claim 9, wherein the object is selected from a group consisting of a MMS message, a SMS message, an audio file, a video file, a text file, and an image file.

15. The computer program product of claim 9, further comprising computer code for enabling a user to define rights to the object for those outside of the electronic device.

16. An electronic device, comprising:
a controller;
a server operatively connected to the controller, and
a memory unit operatively connected to the controller and the server, wherein the memory unit includes:
computer code for selecting an object on the module;
computer code for placing the object on a web page located on the electronic device;
computer code for placing the object on the server; and
computer code for making the object on the server available outside of the electronic device.

17. The electronic device of claim 16, wherein the memory unit further includes computer code for automatically registering the object with a search engine.

18. The electronic device of claim 16, wherein the memory unit further includes computer code for enabling a user to define rights to the object for those outside of the electronic device.

19. The electronic device of claim 16, further comprising:
a display operatively connected to the controller, and
an input device operatively connected to the controller, wherein the object appears on the display for selection by use of the input device.

20. A module, comprising:
a controller;
a server operatively connected to the controller, and
a memory unit operatively connected to the controller and the server, wherein the memory unit includes:
computer code for selecting an object on the module;
computer code for placing the object on a web page located on the electronic device;
computer code for placing the object on the server; and
computer code for making the object on the server available outside of the module.
